(19) United States
(12) Patent Application Publication
(10) Pub. No.: US 2026/0099057 A1
(43) Pub. Date: Apr. 9, 2026

(54) AUDIO-OPTICAL HEADSET

(71) Applicant: ALPHAMICRON INCORPORATED, Kent, OH (US)

(72) Inventors: Bahman Taheri, Shaker Heights, OH (US); Pedro Coutino Soto, Kent, OH (US); Tamas Kosa, Hudson, OH (US)

(73) Assignee: ALPHAMICRON INCORPORATED, Kent, OH (US)

(21) Appl. No.: 19/350,869

(22) Filed: Oct. 6, 2025

Related U.S. Application Data
(60) Provisional application No. 63/703,709, filed on Oct. 4, 2024.

(51) Int. Cl. G02B 27/01; H04R 1/02; H04R 1/10

(52) U.S. Cl. CPC G02B 27/0176; H04R 1/028; H04R 1/1008; H04R 1/105; G02B 2027/0156; H04R 2499/15

(57) ABSTRACT

An audio-optical headset includes a head-mount structure and an audio system attached to the head-mount structure. The audio system includes left and right speakers positionable proximate a user's left and right ears, respectively. The headset further includes an optical system including a variable transmission visor (VTV) having an electronic lens, wherein the VTV is rotatably attached to the head-mount structure or the audio system to allow a first position where the VTV is positioned in front of a user's eyes and a second position where the VTV is positioned over the user's head.

### CROSS-REFERENCE TO RELATED APPLICATIONS

This application claims priority to, and any other benefit of, U.S. Provisional Patent Application Ser. No. 63/703,709, entitled AUDIO-OPTICAL HEADSET, filed Oct. 4, 2024, the entire contents of which is fully incorporated herein by reference

### TECHNICAL FIELD

The present disclosure relates to headsets having both audio and optical functions. In particular, headsets of the present disclosure include an audio system and a variable transmission visor that can be positioned in front of a user's eyes or above their head.

### BACKGROUND

Eyewear with electronically active lenses have many possible uses. In some cases, electronically active lenses may have a variable light transmission function that allows the user to darken the lens, e.g., in bright sunlight. Not only can this increase the visual comfort of the wearer, but such functionality may also be critical in situations requiring keen vision, as may be experienced by aviators, military personnel, law enforcement officers, sports enthusiasts, or the like. Such eyewear may be adjustable to low light situations, e.g., indoors, where dimming is reduced or turned off. Even in a clear state, electronically dimming eyewear can still be in the way or detract from a person's vision under low light conditions. Electronically dimming eyewear can be bulky, heavy, and physically uncomfortable over time. For example, its weight may press on a user's nose and/or ears to produce soreness or headaches. This may be especially the case when they eyewear includes other functionality, such as technology for extended reality (XR), augmented reality (AR), virtual reality (VR), mixed reality (MR), or the like. Further, a user may also wish to listen to audio, such as music, a podcast, a broadcast, or the like, and the electronic eyewear may not fit well with the audio device leading to difficulties with both.

Thus, there is a desire for audio-optical headsets that address one or more of the issues noted above.

### SUMMARY

An audio-optical headset is provided that includes a head-mount structure and an audio system attached to the head-mount structure. The audio system includes left and right speakers positionable proximate a user's left and right ears, respectively. The headset further includes an optical system including a variable transmission visor (VTV) having an electronic lens. The VTV is rotatably attached to the head-mount structure or the audio system to allow a first position where the VTV is positioned in front of a user's eyes and a second position where the VTV is positioned over the user's head.

The audio-optical headset of the present disclosure may provide one or more of the following benefits including, but not limited to, decreased weight, improved weight distribution, more compact design, increased user comfort, longer use without soreness, improved viewing of a person's environment, or improved performance of XR, AR, VR, or MR functionality.

### BRIEF DESCRIPTION OF DRAWINGS

FIGS. 1A-1E are various views of an audio-optical headset according to some embodiments.

FIG. 2 is a side view of another audio-optical headset according to some embodiments.

FIG. 3 is a side view of another audio-optical headset according to some embodiments.

FIG. 4 is a front view of another audio-optical headset according to some embodiments.

FIG. 5 is a front view of another audio-optical headset according to some embodiments.

FIG. 6A is a perspective view of a visor substrate according to some embodiments.

FIG. 6B is a perspective view of a VTV made using the visor substrate of FIG. 6A according to some embodiments.

FIGS. 7A-7C are perspective views of various VTVs according to some embodiments.

FIG. 8 is a front view of a segmented electronic lens according to some embodiments.

FIGS. 9A-9E are side view schematics showing various audio-optical headsets in place on a user's head.

### DETAILED DESCRIPTION

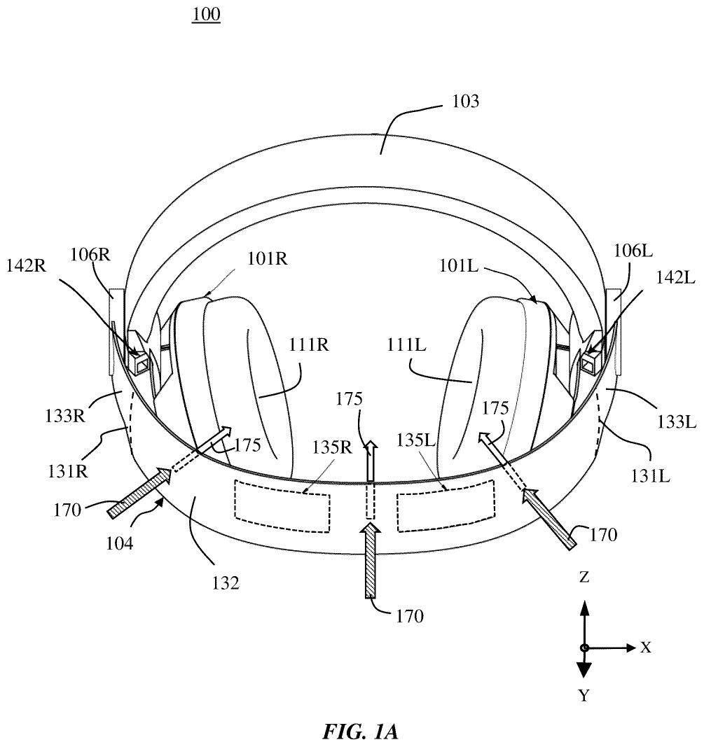

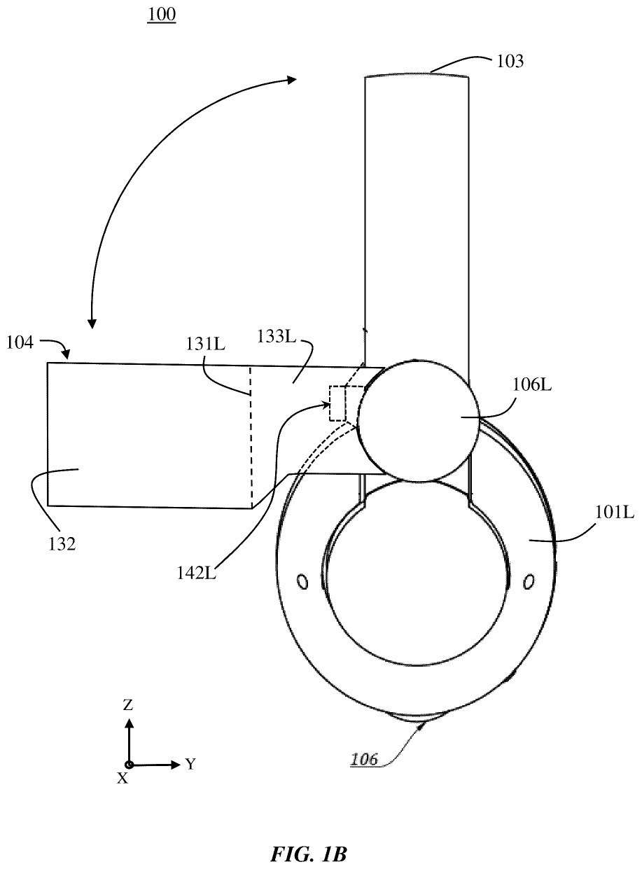

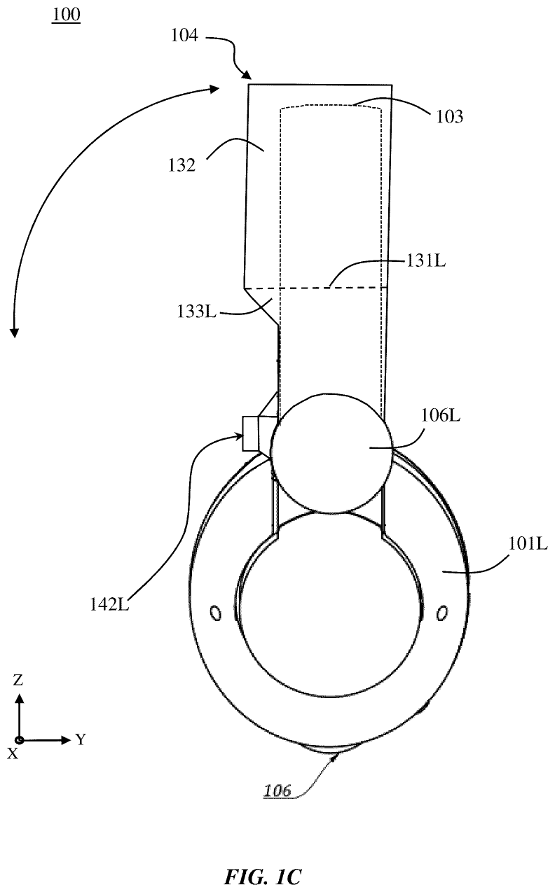

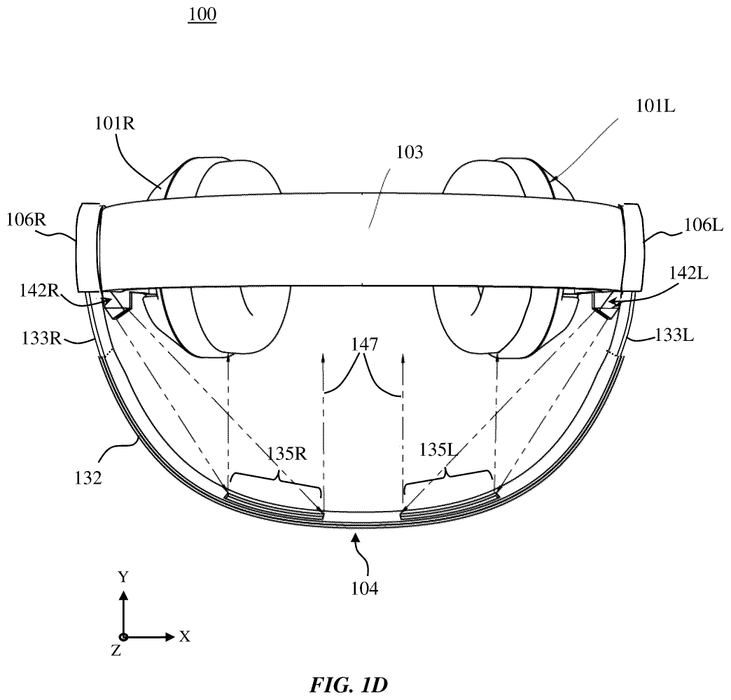

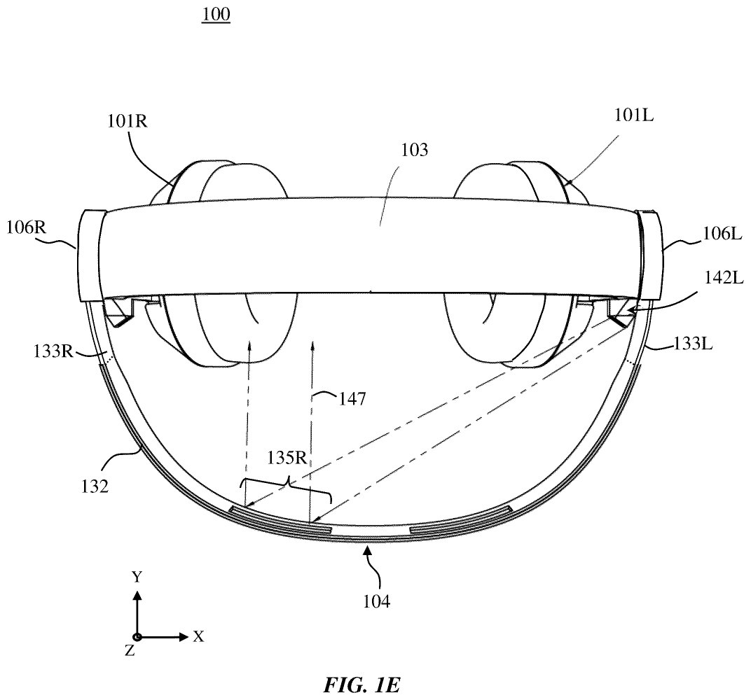

FIG. 1A is a front elevated perspective view of a non-limiting example of an audio-optical headset 100 according to some embodiments. FIGS. 1B and 1C are side views of audio-optical headset 100. FIGS. 1D and 1E are top views of audio-optical headset 100. For additional perspective, XYZ coordinate axes are shown for some figures herein. Audio-optical headset 100 includes a head-mount structure 103 and an audio system that may include left and/or right housings 101L, 101R attached to the head-mount structure 103. The left and right housings may support left and right speakers 111L, 111R, respectively positionable proximate a user's left and right ears. As discussed later, the left and/or right housings may optionally include other components that operate or power the audio system and/or the optical system described below. The audio-optical headset 100 further includes an optical system which may include a variable transmission visor (“VTV”) 104 having an electronic lens 132 (or optionally a set of multiple electronic lenses such as left and right electronic lenses) capable of electronically adjusting the properties of incident light 170 from an outside environment incident on at least a portion of the VTV and transmitted to a viewer (i.e., the user of the audio-optical headset) as transmitted light 175. Note that, unless otherwise noted or clear from the context, the term “electronic lens” may refer to a single lens or to a set of two or more electronic lenses that may be commonly or individually controlled. In FIG. 1A, the electronic lens 132 is provided in an area of the VTV corresponding to the portion between dashed lines 131L and 131R.

With respect to incident light transmitted to the user, the electronic lens 132 may adjust its hue, tint, polarization, brightness, scatter, focus, direction, or the like. That is, the variable transmission provided may include variable hue, variable tint, variable polarization, variable brightness, variable scatter, variable focus, or variable light redirection. The VTV may be characterized by a light transmissive portion through which light from the outside environment (environment light) may be received by a user, e.g., environment light that is incident within a viewing area which may be viewed directly, or environment light that is incident at or beyond a user's peripheral vision but is scattered or reflected so that it may still reach the user's eye. As discussed elsewhere herein, the electronic lens 132 may in some cases cover only a portion of the surface area corresponding to the light transmissive portion, but in other embodiments may cover substantially all of the surface area of the light transmissive portion. Note that the terms “light” and “light transmissive portion” are primarily with respect to one or more wavelengths of visible light within a range of 400 nm to 700 nm. Although the electronic lens may be capable of adjusting other regions of the electromagnetic spectrum such as IR or UV radiation, it is capable of adjusting visible light in at least one wavelength within the visible range. Further something that is “light transmissive” means that it transmits at least 30% of incident light for at least one wavelength within the visible range.

VTV 104 may be rotatably attached to the head-mount structure (as shown here using left and right rotatable attachment mechanisms 106L, 106R) or alternatively to the audio system (e.g., the left and right housings) to allow a first position where the VTV is positioned in front of a user's eyes (as shown in FIGS. 1A and 1B) or a second position where the VTV is positioned above the user's head (side view FIG. 1C). In some cases, the VTV 104 may include left and right VTV arms 133L and 133R that are connected to the portion of the VTV having electronic lens 132. Such arms are optionally extendable. Some or all of the VTV (e.g., electronic lens 132, arm 133L, and/or arm 133L) may be flexible (e.g., bendable or twistable by at least 5 degrees relative to a rest position without breaking or compromising functionality). In some cases, and as shown in the non-limiting example of FIG. 1A, VTV 104 has a unitary structure and may, for example, include a clear plastic substrate with the electronic lens 132 laminated thereto and the two ends of the plastic substrate acting as arms 133L and 133R. Although shown as extending only partially back towards the rotatable attachment mechanisms 106L, 106R, electronic lens 132 may extend further or all the way back to the attachment mechanism (e.g., over some of the arms of the VTV to adjust peripheral environmental light incident on the VTV 104). Alternatively, the electronic lens may not extend as far back as shown in FIG. 1B and/or may optionally only occupy a smaller portion of the user's field of view. In some embodiments, the VTV may optionally include a frame for holding the electronic lens(es) and which may connect to left and right VTV arms.

In some embodiments, the optical system may further include display technology (e.g., one or more projectors, microdisplays, see-through displays . . . , etc.), combiner optics, or other optical elements for providing Augmented Reality (AR), Mixed Reality (MR), Virtual reality (VR), or extended reality (XR) types of functionality. For example, the display technology may include left and right projectors 142L and 142R attached to, or provided as part of, housings 101L and 101R, or which may alternatively be attached to head-mount structure 103, or even to the VTV. Left and right combiner optics 135L and 135R may in some cases be provided on the inside surface of VTV 104 (the side toward a user's eyes). In some embodiments, rather than being right at the inside surface, the combiner optics may be incorporated into the VTV interior or there may be a protective layer covering the combiner optics. The combiner optics may in some cases be interposed between the user's eyes and the electronic lens 132 of the VTV.

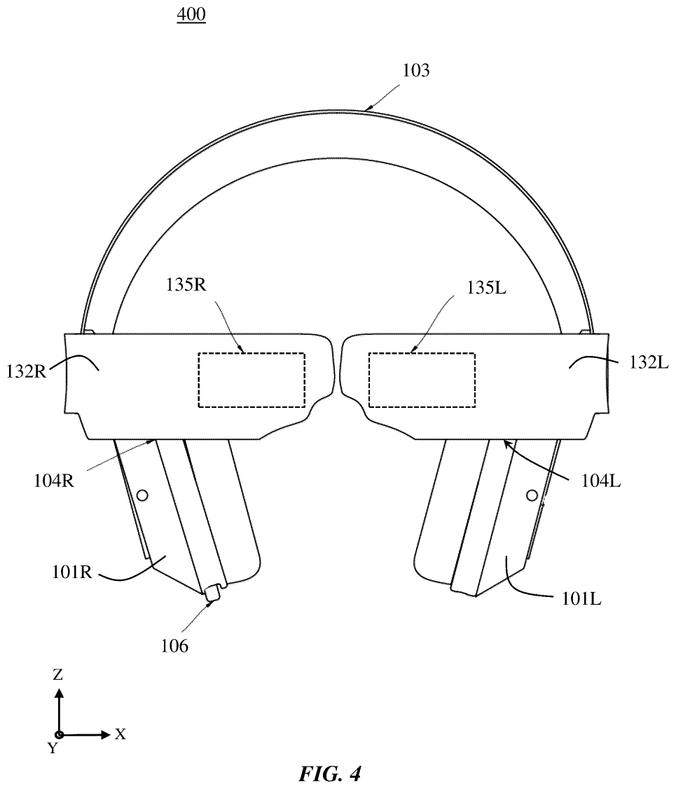

The combiner optics may include a half mirror, a waveguide, a prism, a dichroic mirror, a beamsplitter, or other optical components, that cooperate with the projector or other display optics to produce an image viewable by the user. This image may be overlaid onto the scene the viewer is looking at through the VTV 104 so that the viewer sees both the display image and the ambient scene, and the viewer further receives whatever light adjustment the electronic lens 132 is providing. Turning to FIG. 1D, projectors 142L and 142R project light onto the respective combiner optics 135L and 135R which redirect or otherwise act on the projection light to produce display light 147 that is directed toward the user's left and right eyes. In some other embodiments, as shown in FIG. 1E, projector 142L may instead project light onto the right combiner optics 135R which is directed to the user's right eye as display light 147. Although not shown in FIG. 1E, the right projector and left combiner optics may operate similarly. In some cases, rather than combiner optics, parts 135L and 135R may correspond to see-through displays. Although the embodiments shown include both right and left projectors and combiners, it is contemplated that in some embodiments, only one projector/combiner may be used in front of one eye and not the other. As discussed later with respect to FIG. 4, the user may have the option of having the visor in front of just one eye and not the other. Although FIGS. 1D and 1E show the electronic lens 132 on the outside surface of the VTV, the electronic lens may instead be provided on the inside surface or incorporated into the VTV interior, or there may be an outside layer of protective material covering the electronic lens 132.

In some embodiments, the AR, MR, VR, or XR functionality can be enhanced by the variable transmission visor. For example, the VTV may be set to transmit ambient light from a scene at a particular brightness, polarization, contrast, hue, tint, or the like, that improves the combination of the scene image with the overlayed digital display image. In another example, the VTV may be set to allow very little light transmission so that the user can focus solely on the digital display image. In some cases, the operation of the VTV may be used to switch between reality modes, e.g., including but not limited to between AR and VR.

In some embodiments, the left and/or right housings 101L/101R may include at least some of the electronics (e.g., a microcontroller) for controlling the audio system, the optical system, or other systems. In some embodiments, the left and/or right housings may include a power source such as a battery for powering the audio-optical headset. An advantage to providing the electronics and power source in the left or right housings is that their weight and bulk are removed from VTV portion of the system. The weight can be partially distributed over the user's head where the head-mount structure rests rather than directly behind the cars or on a user's nose. This may also allow the VTV to have a sleeker design that is less obtrusive when stored or positioned above a user's head. In some embodiments when positioned above the user's head, the VTV may be less than 15 cm from the top of the user's head, alternatively, less than or equal to 10 cm, 9 cm, 8 cm, 7 cm, 6 cm, 5 cm, 4 cm, 3 cm, 2 cm, 1 cm, or 0.5 cm. In some cases, when positioned above the user's head, the distance between the VTV and the top of the user's head may be in a range of 0.5 cm to 1 cm, 1 cm to 2 cm, 2 cm to 3 cm, 3 cm to 4 cm, 4 cm to 5 cm, 5 cm to 6 cm, 6 cm to 7 cm, 7 cm to 8 cm, 8 cm to 9 cm, 9 cm to 10 cm, 10 cm to 15 cm, or any combination of ranges thereof.

In some cases, some portion of the electronics, microcontroller, power source, and/or other operational elements may, in addition to (or instead of) being provided in or on left and right housings, be located elsewhere on the audio-optical headset, e.g., on the head-mount structure or on the VTV. In some cases, some portion of the electronics, microcontroller, the power source, or operational elements may have their own containment or housing separate from the left and right housings. The audio system and optical systems each require electronics for controlling their functions. In some cases, the audio system electronics and the optical system electronics each include its own dedicated controller. In some cases, the audio system electronics and the optical system electronics are at least partially (or even fully) integrated via a common controller. Power source(s) or operational elements used by the audio and optical systems may be separate, or alternatively, at least partially (or even fully) integrated and shared.

The audio-optical headset may include operational elements such as buttons, switches, touch sensors, or the like, that may be used to activate various functions of the audio-optical headset. In some embodiments, such operational elements may be included in the left and/or right housings, which are typically easily accessed by a user's hands. For example, FIGS. 1B and 1C show a control wheel 106 as just one non-limiting example. In some cases, the audio-optical headset, e.g., the left and/or right housings, may include wireless communication electronics (Wi-Fi, Bluetooth, etc.) to allow some of the systems functionality to be controlled or monitored remotely. The audio-optical headset may further include one or more antennas, e.g., attached to (or provided on) the head-mount structure 103, the VTV 104, and/or one or both of the left/right housings 101L/101R.

The audio-optical headset may further include sensors, e.g., a light sensor, a laser sensor, a CMOS sensor, a CCD sensor, a temperature sensor, a biometric sensor, an accelerometer, a vibration sensor, an audio sensor, a GPS sensor, a gyroscope, or a microphone. The audio-optical headset may further include one or more lights such as LEDs, e.g., for displaying operational status or for area illumination. There is no particular limitation on where such sensors or lights may be provided on the audio-optical headset, so long as their location serves the intended function. In some cases, the operation of the audio-optical headset may be linked in part to feedback from sensors. For example, data input from a light sensor may trigger the electronic lens to change its state with respect to how it adjusts incident light.

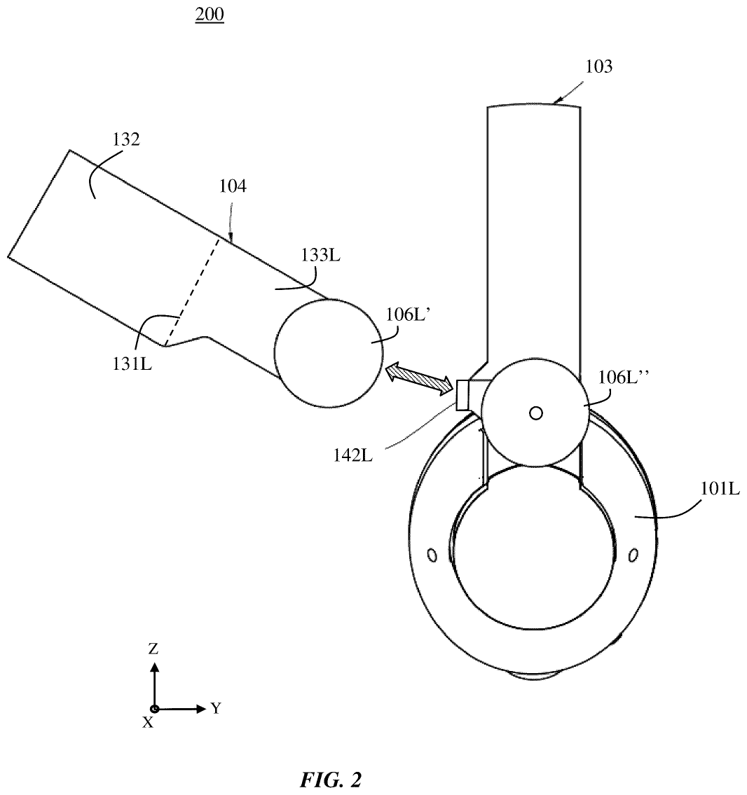

FIG. 2 is a side view of another audio-optical headset 200 according to some embodiments. Audio-optical headset 200 may be similar to audio-optical headset 100, except that VTV 104 is reversibly detachable for easy cleaning, replacement, or safe storage when not needed. In some cases, the rotatable attachment mechanism may include a first piece 106L′ that, when the VTV is reversibly detached, remains part of the VTV and a second piece 106L″ that remains attached to head-mount structure 103.

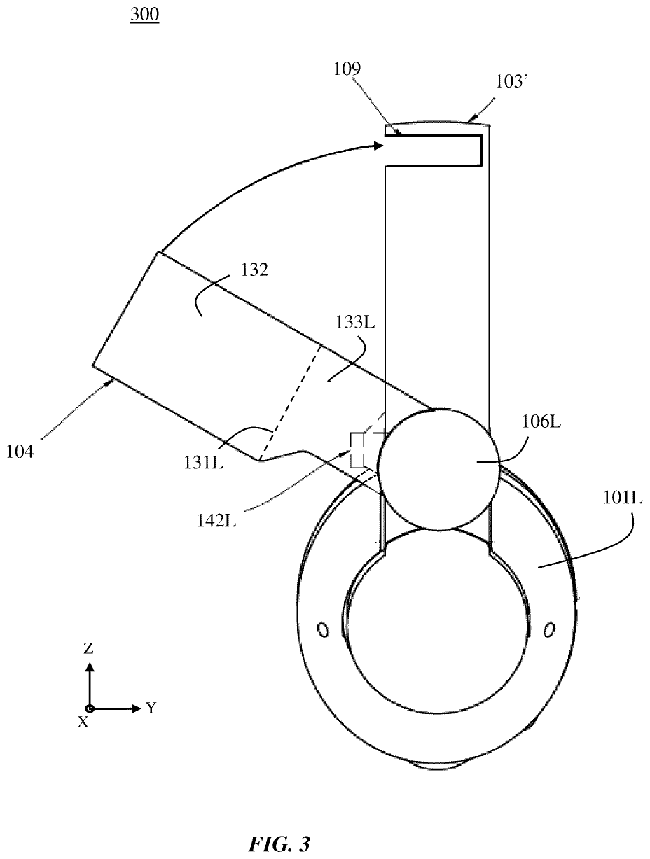

FIG. 3 is a side view of another audio-optical headset 300 according to some embodiments. Audio-optical headset 300 may be similar to audio-optical headset 100, except that the head-mount structure 103′ includes a storage cut-out 109 to hold or protect the VTV 104 when in the second position.

FIG. 4 is a front view of another audio-optical headset 400 according to some embodiments. Audio-optical headset 400 may be similar to audio-optical headset 100, except that VTV 104 has been separated into left and right VTV segments, 104L and 104R, respectively. Each VTV segment may include an electronic lens (132L, 132R) and combiner optics (135L, 135R). Both VTV segments are shown in their first position, but one or both may be moved to their respective second position above the user's head when not needed. In some cases, the headset 400 may include only a single projector and only one of the VTV segments includes combiner optics. In some cases, only one VTV segment includes an electronic lens. In some embodiments, the headset may include only one VTV segment for one eye.

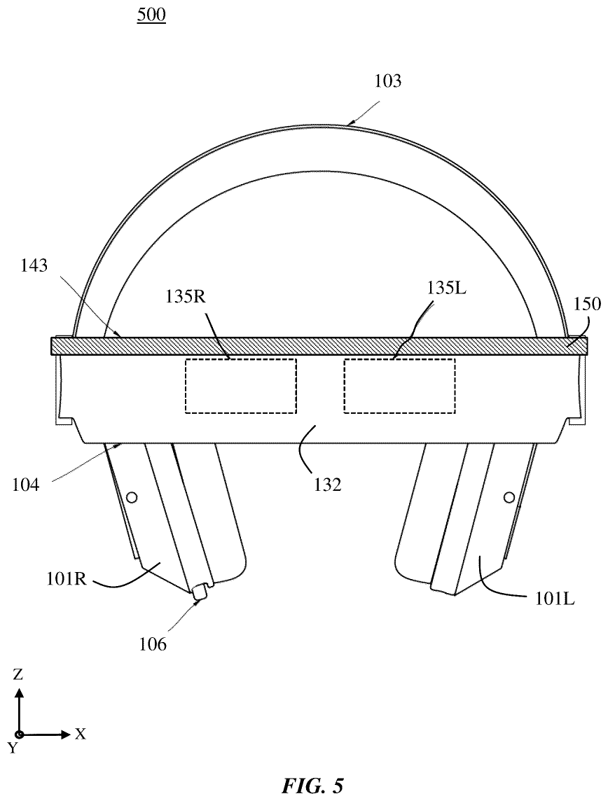

FIG. 5 is a front view of another audio-optical headset 500 according to some embodiments. Audio-optical headset 500 may be similar to audio-optical headset 100, except that an optional projector 143 (or some other display technology) is provided directly on the VTV 104, e.g., attached to or incorporated into frame 150. In this view, projector 143 is positioned behind frame 150 and not visible. In some cases, a projector situated on frame 150 may directly project light to the viewer's eyes and optical combiners may not be needed when XR, AR, VR, or MR is desired.

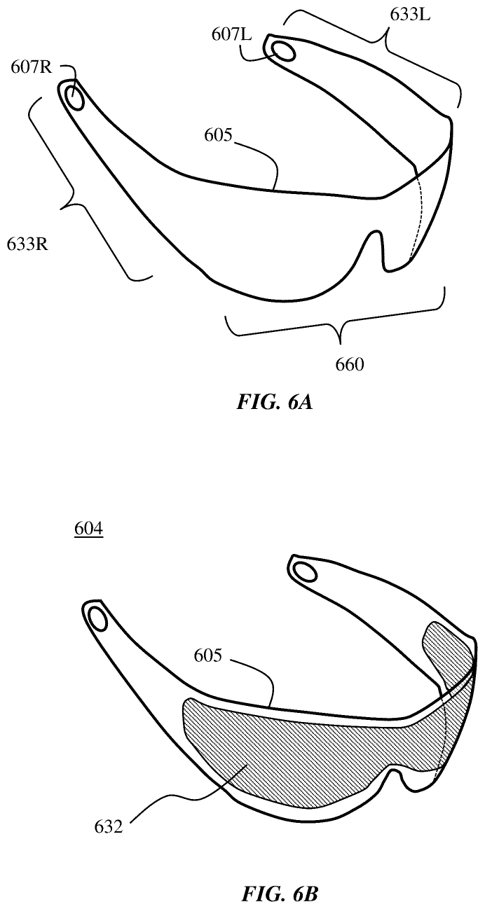

As mentioned, not all of the light transmissive area of a VTV is necessarily covered by an electronic lens. FIG. 6A is a perspective view of a non-limiting example of a visor substrate 605 onto which an electronic lens and optionally other components may be provided. In some embodiments, visor substrate 605 may be a light transmissive piece of plastic that can be used for VTVs having a substantially unitary structure. Visor substrate 605 may be flexible. Visor substrate 605 (which in this embodiment may also be referred to as a light transmissive substrate) may in some cases be a continuous plastic structure having portions generally corresponding to left and right arms 633L, 633R and a central viewing portion 660 generally corresponding to a user's forward viewing area. Openings 607L, 607R in the left and right arms are also shown which may cooperate with or form part of the rotatable attachment mechanisms. In some cases, there may not be a well-defined boundary between the arms 633L, 633R and the central viewing portion 660. When there is no clear boundary, the arm may in some embodiments be defined as the region from the attachment mechanism up to about the beginning of a person's lateral field of vision.

FIG. 6B is a perspective view of VTV 604 made by attaching an electronic lens 632 to the visor substrate 605 from FIG. 6A. For clarity, not all of the features are marked, but they are self-evident with reference to FIG. 6A. Since visor substrate 605 of the present non-limiting example is clear plastic, substantially all of its surface area is transmissive to light. Here, electronic lens 632 covers only a portion of the light transmissive surface area of VTV 604. In this case, it covers most (but not all) of the central viewing portion as well as some of the portions corresponding to the left and right arms. The latter may be beneficial for adjusting light at the user's periphery. Although not shown, VTV 604 may further include one or more optical combiners or other features when the audio-optical system includes XR, AR, VR, or MR capabilities.

In some cases, the electronic lens 632 may be laminated to the outer surface of visor substrate 605 (the surface away from the user's head), laminated to the inner surface of visor substrate 605 (the surface proximate the user's head), or provided within the substrate. Although not shown, one or more additional layers may be provided over the electronic lens, e.g., to protect it from physical damage such as scratches, where the electronic lens is interposed between the substrate and the one or more additional layers.

FIG. 7A is a perspective view of another VTV according to some embodiments.

In FIG. 7A, VTV 704 is illustrated without its electronic lens so that other features may be first described. VTV 704 includes a central viewing portion 760 that includes a light transmissive substrate 705 that is supported by frame 750. The light transmissive substrate 705 may include a single layer of light transmissive material or alternatively may have a multilayer structure. Light transmissive substrate 705 may in some cases be made from plastic, glass, or a combination thereof. Frame 750 in the present example is not transparent (but in other embodiments may be transparent) and is typically made from plastic, metal, or a combination thereof.

VTV 704 further includes a set of adjustable left and right arms 733L, 733R. Each adjustable arm includes a fixed arm element 736L, 736R proximate or connected to the central viewing portion 760, e.g., connected to the frame 750 at the left and right sides. The fixed arm elements in the present example are not light transmissive, but in alternative embodiments may be light transmissive. Each adjustable arm includes a slidable arm element 737L, 737R which can slide in direction 739 (towards or away from central viewing portion 760) to adjust the overall length of the VTV. The ends of the slidable arm elements may include a rotatable attachment mechanism, e.g., rotatable attachment mechanism 706L shown for the left arm.

FIGS. 7B and 7C are perspective views showing two different configurations with respect to the electronic lens. In FIG. 7B, electronic lens 732b substantially covers all of the light transmissive surface area of VTV 704b (corresponding to light transmissive substrate 705). In FIG. 7C, electronic lens 732c covers only a portion of the light transmissive surface area of VTV 704c (corresponding to light transmissive substrate 705).

In some cases, the electronic lens 732b or 732c may be laminated to the outer surface of light transmissive substrate 705 (the surface away from the user's head), laminated to the inner surface of light transmissive substrate 705 (the surface proximate the user's head), or provided within the light transmissive substrate. Since the frame supports the light transmissive substrate, the frame therefore also supports the electronic lens. Although not shown, one or more additional layers may be provided over the electronic lens, e.g., to protect it from physical damage such as scratches, where the electronic lens is interposed between the substrate and the one or more additional layers. Although not shown, VTV 704, 704b, or 704c may further include one or more optical combiners or other features when the audio-optical system includes XR, AR, VR, or MR capabilities.

Note that in some embodiments, the electronic lens may be an integral part of the light transmissive substrate structure itself, rather than being separately attached or laminated. In such cases, the frame may be said to support the electronic lens directly. An electronic lens typically has at least one, and more typically, two electronic lens substrates with electronically active material disposed therebetween. In some embodiments, one or both electronic lens substrates may also act as the light transmissive substrate 705.

In any of the VTV embodiments herein, a light transmissive portion of the VTV (e.g., a light transmissive substrate) whether covered by an electronic lens or not may have predetermined non-electronic optical properties. For example, through the use of dyes or various layer structures, a light transmissive substrate may passively (non-electronically) absorb some light, have a tint, act as a polarizer, reflect some light, or the like, but it generally transmits at least 30% of incident environment light at least one wavelength in the visible region. In some cases, a light transmissive substrate may include one or more non-electronic photochromic dyes that darken upon exposure to UV radiation and lighten upon removal of such exposure to UV radiation.

As mentioned, an electronic lens may cover substantially all (˜100%) or only a portion less than 100%) of the light transmissive surface area of the VTV. In some embodiments, the % coverage of the VTV's light transmissive surface area by the electronic lens (including all electronic lenses if more than one) may be at least 5%, optionally in a range of 10-20%, 20-30%, 30-40%, 40-50%, 50-60%, 60-70%, 70-80%, 80-90%, 90-95%, 95-98%, or 98-100%. Note that such coverage is with respect to an active area of the electronic lens device that adjusts incident light.

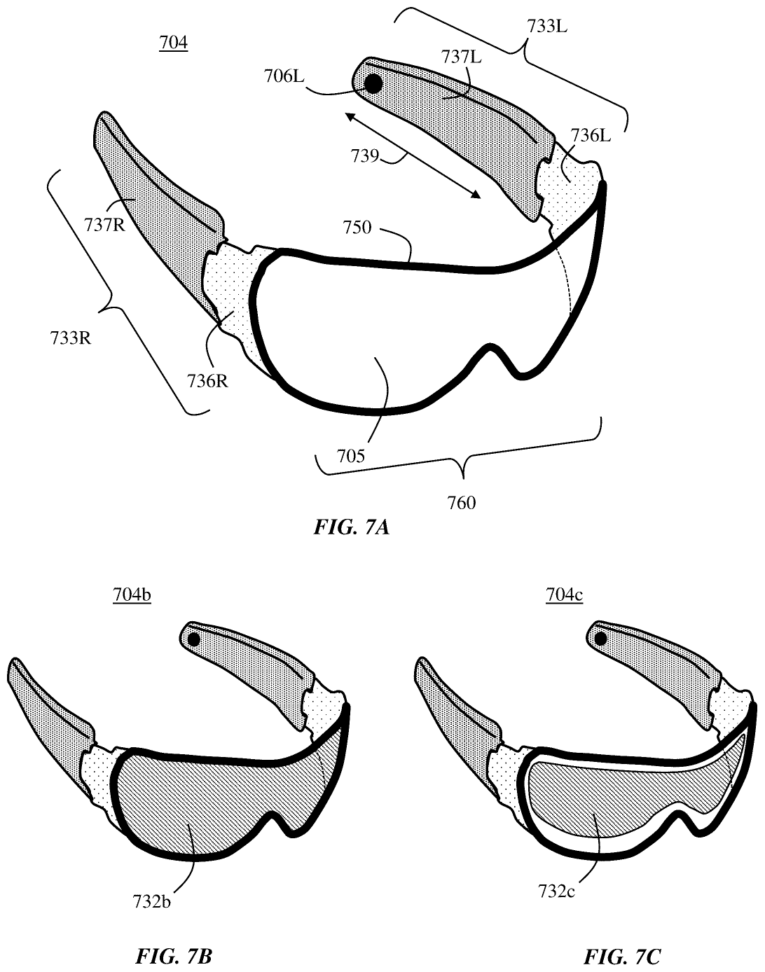

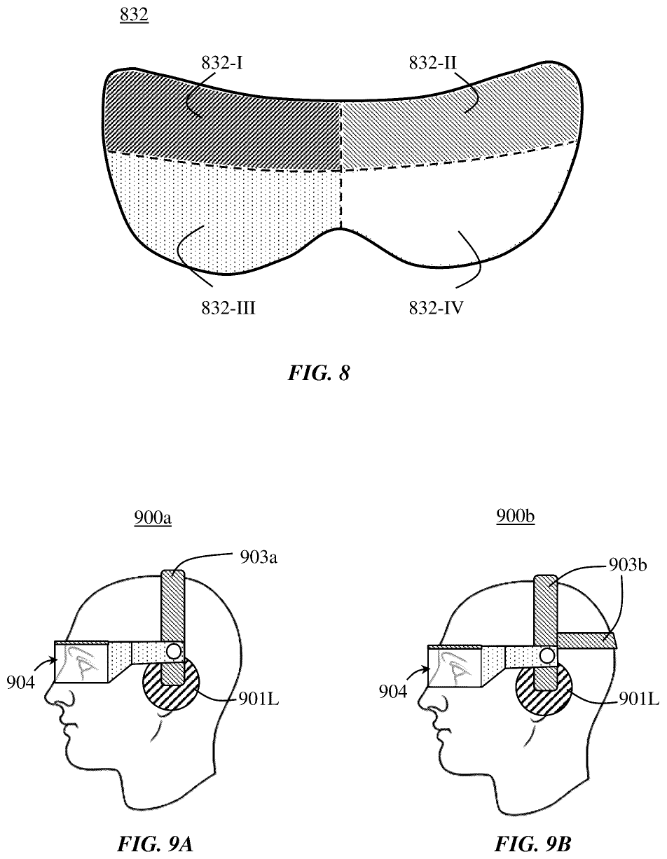

FIG. 8 is a front view of another electronic lens according to some embodiments. Any electronic lens may optionally include two or more individually addressable areas or segments (a “segmented electronic lens”) such that incident light can be adjusted locally across the electronic lens. For example, segmented electronic lens 832 includes 4 segments that are individually electronically controllable (individually addressable), segments 832-I, 832-II, 832-III, and 832-IV. In this non-limiting example, each segment of the segmented lens may be capable of multiple levels of adjustment with respect to incident light. For example, segment 832-IV may be set to its least light-absorbing state (most light-transmissive state), whereas segment 832-I may be set to its highest light-absorbing state (least light-transmissive state). Segments 832-II and 832-III may be set to differing intermediate levels of light absorption (intermediate light transmission).

There is no particular limit on the number of segments, but adding segments may increase the complexity of the drive electronics needed to operate the electronic lens. In some embodiments, the number of segments in a segmented electronic lens may be in a range of 2-5, 5-10, 10-15, 15-20, 20-25, 25-50, 50-100, or any combination of ranges thereof. In some cases, the number of segments may exceed 100.

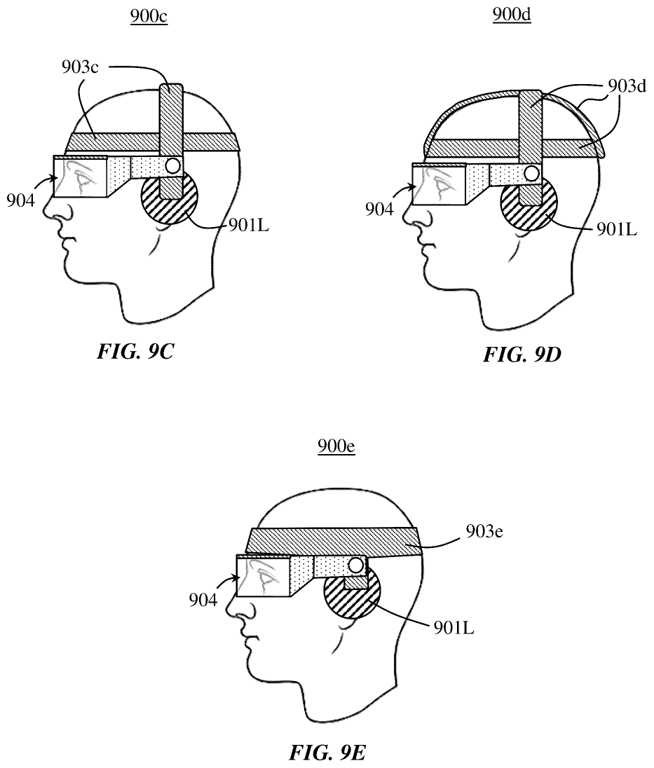

FIGS. 9A-9E are side view schematics showing various audio-optical headsets in place on a user's head, and in particular, illustrating various non-limiting examples of head-mount structures. Each audio-optical headset shown includes a variable transmission visor 904 and an audio system including (in this view) a left audio housing 901L.

Audio-optical headset 900a of FIG. 9A includes a head-mount structure 903a that is similar to head-mount structure 103 which includes a first-type headband element extending over the top of the user's head from left to right in approximate alignment with the user's ears.

Audio-optical headset 900b of FIG. 9B includes a head-mount structure 903b that is similar to that of FIG. 9A but further includes a second-type headband element extending from the left side of the first-type headband element, around the back of the user's head, and to the right side of the first headband element. The first-type and second-type headband elements are generally connected.

Audio-optical headset 900c of FIG. 9C includes a head-mount structure 903c that is similar to that of FIG. 9A but further includes a third-type headband element extending laterally around the full circumference of the user's head and is generally connected to the first-type headband element.

Audio-optical headset 900d of FIG. 9D includes head-mount structure 903d that is similar to that of FIG. 9C, but further includes a fourth-type headband element extending from the front of the third-type headband element, over the user's head, and to the rear of the third-type headband element. The fourth-type headband element is generally connected to the third-type headband element, and may optionally be connected to the first-type headband element.

Audio-optical headset 900e of FIG. 9E includes head-mount structure 903e that includes a third-type headband element extending laterally around the full circumference of the user's head (without the first-type headband element).

Note that any of the head-mount structures disclosed herein may be adjustable, flexible, or both with respect to their dimensions so that they may fit comfortably on a wide variety of head shapes and sizes. Although not shown, areas between different headband elements may optionally include a fabric or mesh.

Although many of the drawings have shown speakers as cupped headphones that fit over the cars, the speakers may instead be provided as earbuds that fit partially in the car or as bone conduction headphones. The audio system may further include noise cancelling technology.

The electronic lens of the VTV may include one or more of a liquid crystal (LC) device, an electrochromic optical device, a reversible metal electrodeposition device, a switchable polarizer device, a graduated electro-optic device, an electronic lensing/focusing device (i.e., that alters the direction or focus of incident light), or a switchable light reflective device. Any one or more LC configurations are contemplated, including Twisted Nematic (TN), Hyper Twisted Nematic (HTN), Super Twisted Nematic (STN), Film Compensated Super Twisted Nematic (FSTN), Wide View Twisted Nematic (WVTN), Vertically Aligned Nematic liquid crystal (VA or VAN), In-Plane Switching (IPS) and Fringe Field Switching (FFS), Multidomain Vertically Aligned (MVA and PVA), Axially Symmetric Vertically Aligned aka Advanced Super View (ASV), Amplified Intrinsic Fringe-Field Multidomain Vertically Aligned (AIFF MVA), and any other LC configuration known in the art.

The electronic lens may have at least a first state and second a second state where the second state more strongly adjusts the incident light than the first state. For example, relative to the first state, the second state may absorb more incident light, reflect more incident light, scatter more incident light, alter the polarization of more incident light, redirect or focus more incident light, or the like. In some cases, there may be multiple adjustment levels or a gradient of adjustment levels between the first and second states.

In some embodiments, the electronic device may be an LC device as described in any of the following patent documents: U.S. Pat. Nos. 6,239,778; 9,513,524; 12,117,701; 12,204,222; 12,332,524; 12,222,623; or U.S. Patent Publication No. 2024/0402548; the entire contents of which are incorporated herein by reference for all purposes. In some cases, the LC devices may include a guest-host system having a liquid crystal host and a dichroic dye guest (optionally the dichroic dye may be a photodichroic dye).

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

As used herein, a phrase that recites a range of values is inclusive of the end values, for example, “between X and Y,” “range of X to Y,” “from X to Y,” includes X and Y, or the phrase “up to Y” includes Y. Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the layer” includes reference to one or more layers and equivalents thereof known to those skilled in the art, and so forth. The invention has now been described in detail for the purposes of clarity and understanding. However, it will be appreciated that certain changes and modifications may be practiced within the scope of the appended claims.

All publications, patents, and patent applications cited herein are hereby incorporated by reference in their entirety for all purposes. None is admitted to be prior art.

We claim:

1. An audio-optical headset comprising:
a) a head-mount structure;
b) an audio system attached to the head-mount structure, the audio system comprising left and right speakers positionable proximate a user's left and right ears, respectively; and
c) an optical system comprising a variable transmission visor (VTV) having an electronic lens, wherein the VTV is rotatably attached to the head-mount structure or the audio system to allow a first position where the VTV is positioned in front of a user's eyes and a second position where the VTV is positioned over the user's head.

2. The audio-optical headset of claim 1, wherein the VTV comprises i) a frame supporting the electronic lens, and ii) left and right arms extending from the frame to the head-mount structure or to the audio system.

3. The audio-optical headset of claim 2, wherein the left and right arms are adjustable with respect to their length.

4. The audio-optical headset of claim 1, wherein a portion of the VTV is flexible.

5. The audio-optical headset of claim 1, wherein the variable transmission comprises variable tint, variable hue, variable brightness, variable polarization, variable scatter, or variable focus.

6. The audio-optical headset of claim 1, wherein the electronic lens comprises a liquid crystal device, an electrochromic optical device, a reversible metal electrodeposition device, a switchable polarizer device, a graduated electro-optic device, or an electronic lensing/focusing device.

7. The audio-optical headset of claim 6, wherein the liquid crystal device comprises a guest-host mixture including a liquid crystal host and a dichroic or photodichroic dye guest.

8. The audio-optical headset of claim 1, wherein the electronic lens includes separate left and right electronic lenses.

9. The audio-optical headset of claim 1, wherein the electronic lens is a segmented electronic lens comprising two or more individually addressable areas.

10. The audio-optical headset of claim 1, wherein the VTV is characterized by a light transmissive surface area, and wherein the electronic lens covers 95-100% of the light transmissive surface area.

11. The audio-optical headset of claim 1, wherein the VTV is characterized by a light transmissive surface area, and wherein the electronic lens covers 10-95% of the light transmissive surface area.

12. The audio-optical headset of claim 1, wherein the audio system comprises at least one housing that: supports a speaker, contains electronics, contains a power source, includes a switch, or any combination thereof.

13. The audio-optical headset of claim 1, wherein the head-mount structure comprises: i) a headband element extending over the user's head from left to right; ii) a headband element extending around a circumference of the user's head; or iii) both (i) and (ii).

14. The audio-optical headset of claim 13, wherein the headband element extending over the user's head comprises a storage cut-out to hold or protect the VTV when in the second position.

15. The audio-optical headset of claim 1, wherein in the second position, a highest point of the VTV is 5 cm or less from a top of the user's head.

16. The audio-optical headset of claim 1, wherein the VTV is reversibly detachable.

17. The audio-optical headset of claim 1, wherein the optical system further comprises display technology to provide Augmented Reality (AR), Mixed Reality (MR), Virtual reality (VR), or extended reality (XR).

18. The audio-optical headset of claim 17, wherein the display technology comprises a see-through display, a projector, or a micro-display.

19. The audio-optical headset of claim 18, wherein the display technology further comprises combiner optics provided on the VTV.

20. The audio-optical headset of claim 1, wherein the VTV comprises a left VTV segment positionable over the user's left eye, a right VTV segment positionable over a user's right eye, or both left and right VTV segments, wherein each VTV segment is individually positionable over the user's head.
